(19) United States
(12) Patent Application Publication
(10) Pub. No.: US 2006/0034487 A1
(43) Pub. Date: Feb. 16, 2006

(54) Method and device for adjusting an image sensor system

(76) Inventor: Matthias Franz, Tuebingen (DE)

Correspondence Address: KENYON & KENYON, ONE BROADWAY, NEW YORK, NY, 10004, US

(21) Appl. No.: 10/532,413

(22) PCT Filed: Nov. 4, 2003
(86) PCT No.: PCT/DE03/03648

§ 371 Date: Apr. 22, 2005

(30) Foreign Application Priority Data
Jan. 24, 2003 (DE) 10302671.1

(51) Int. Cl. G06K 9/00

(52) U.S. Cl. 382/104

(57) ABSTRACT

A method and a device for adjusting at least one parameter of an image sensor of a stereo camera in a motor vehicle. The stereo camera has two image sensors which record essentially the same scene. If an error occurs in one of the image sensors, at least one parameter of this image sensor is adjusted as a function of at least one measured value of the error-free image sensor of the image sensor system. In the preferred exemplary embodiment, the parameter is at least one lighting parameter of the image sensor. In the event of an error of an image sensor of the stereo camera, the at least one lighting parameter is adjusted as a function of at least one measured value of the second image sensor, the measured value being a measure of the lighting of at least one part of the image of the second image sensor.

### FIELD OF THE INVENTION

The present invention relates to a method and a device for adjusting at least one parameter of at least one image sensor of an image sensor system, the image sensor system including at least two image sensors.

### BACKGROUND INFORMATION

Image sensor systems having at least two image sensors which essentially record the same scene are known. Such image sensor systems are also known as “stereo cameras.” European Patent Application No. EP 1 028 387, for example, describes a surroundings sensor device in a motor vehicle having a stereo camera. The stereo camera has two image sensors having overlapping viewing fields. It is provided that the generated surroundings image data of both image sensors be used for detecting traffic signs. The detected traffic signs are displayed to the driver of the vehicle via a head-up display. The stereo camera is thus a component of a driver assistance system for displaying traffic signs in the motor vehicle. Driver assistance systems are systems in a motor vehicle which support the driver in road traffic by providing driver assistance functions. The reliable functioning of driver assistance systems and their components combined with high availability are the prerequisites for the use of these systems in a motor vehicle. European Patent Application No. EP 1 028 387 provides no indication of a method or a device for achieving high availability of an image sensor system having at least two image sensors which essentially record the same scene.

### SUMMARY OF THE INVENTION

The method and device for adjusting at least one parameter of at least one image sensor of an image sensor system, described below, having at least two image sensors recording essentially the same scene, have the advantage that the error tolerance of the image sensor system is enhanced. In a particularly advantageous manner, this generally contributes to high availability of the image sensor system, in particular of the above-described stereo camera. If a monocular error occurs, i.e., an error in only one of the image sensors of the image sensor system, the image sensor system does not necessarily fail. During continuous operation, the method and the device thus contribute to reducing downtimes and thus to increasing availability.

The method and the device described below are advantageous in motor vehicles in particular. Image sensor systems in motor vehicles are used in driver assistance systems and/or in safety-related systems. For example, the use of image sensor systems for recognizing the danger of an accident and preparing safety devices, such as air bags and/or seat belt tensioners, for the possible danger of an accident as a function of the recognized danger situation is planned. This permits controlled and more rapid deployment of these safety devices. Therefore, a high degree of availability is needed when image sensor systems are used in such safety-related systems. The above-described method and device contribute, in a particularly advantageous manner, to the high availability of an image sensor system in motor vehicles. It is also advantageous that the availability of the image sensor system is increased particularly in difficult driving situations such as rain. Such difficult driving situations entail a particularly high danger of an accident, and it is important that the image sensor system has high availability in such driving situations. However, even when image sensor systems are used in driver assistance systems, the method and the device described below advantageously contribute to increasing the availability of the driver assistance functions in difficult driving situations. This is advantageous because many driver assistance functions are designed particularly for use in difficult driving situations where they are needed by the driver.

When adjusting at least one lighting (illumination) parameter, improved error tolerance of the lighting adjustment of the image sensors is advantageously achieved because in the case of an error in at least one image sensor, only the image sensors having error-free lighting information of at least one further image sensor are adjusted. It is particularly advantageous if the gain and/or offset and/or the integration time of the at least one image sensor is/are used as parameters. These parameters are particularly well suited for automatic lighting adjustment and the switchover of the lighting adjustment to at least one error-free image sensor described below. From the point of view of automatic adjustment and/or regulation and/or control of the lighting, a stereo camera has a particular property. The lighting sensor, i.e., the image sensor chip, on which the lighting adjustment depends, for example, is present in duplicate. It is particularly advantageous that in the case of a stereo camera both image sensors record essentially the same scene; and the lighting information obtained by both image sensors is thus essentially identical. This redundancy may be used in the case of an error by using only the lighting information from the error-free image sensor.

Another advantage of the method and the device described below is that at least one image error and/or at least one hardware error is/are recognized as an error type. It is therefore possible not only to recognize image errors, but also errors in the hardware. The method and the device thus advantageously contribute to the high availability of an image sensor system even if an error occurs in the form of at least one hardware error in an image sensor.

Particularly advantageous is a processing unit for generating at least one adjustment signal for at least one parameter of at least one image sensor of an image sensor system for performing all or at least the essential steps of the method described below. The advantages of such a processing unit are the above-described advantages of the method and the device for adjusting at least one parameter of at least one image sensor of an image sensor system.

Particularly advantageous is a computer program having program code means to execute all steps or at least the essential steps of the above-described method if the program is run on a computer. The use of a computer program allows the method to be rapidly and inexpensively adapted, for example, by adapting to different image types. Alternatively or additionally, simple recording of additional error types is possible.

### BRIEF DESCRIPTION OF THE DRAWING

FIG. 1 schematically shows the preferred exemplary embodiment of the present invention.

### DETAILED DESCRIPTION

A method and a device for adjusting at least one parameter of an image sensor of a stereo camera in a motor vehicle are described below. The stereo camera has two image sensors which essentially record the same scene. If an error occurs in one of the image sensors, at least one parameter of this image sensor is adjusted as a function of at least one measured value of the error-free image sensor of the image sensor system. In the preferred exemplary embodiment, the parameter is at least one lighting parameter of the image sensor. In the event of an error or malfunction of an image sensor of the stereo camera, the at least one lighting parameter is adjusted as a function of at least one measured value of the second image sensor, the measured value being a measure of the lighting of at least one part of the image of the second image sensor.

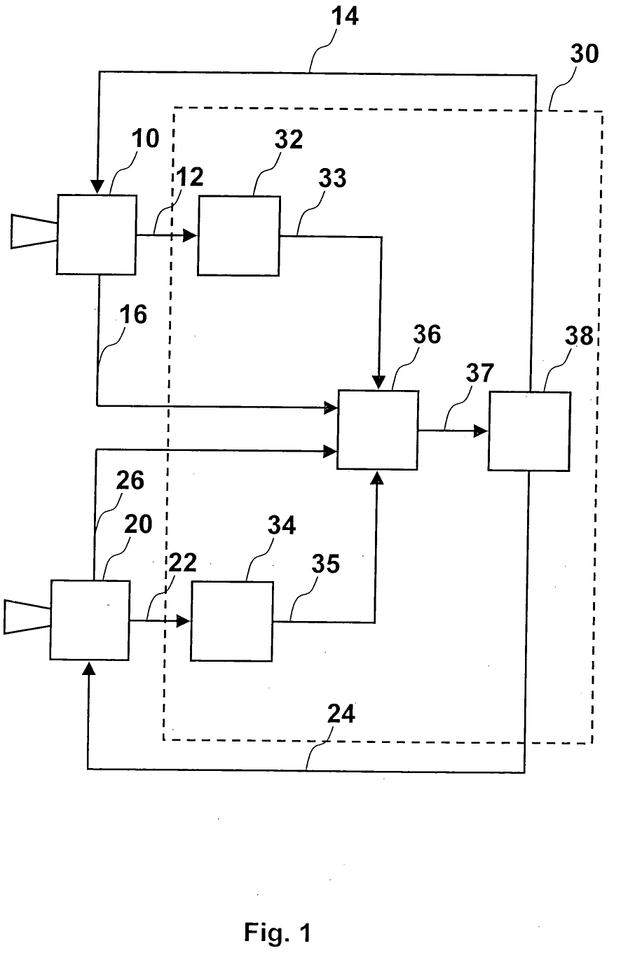

FIG. 1 schematically shows the preferred exemplary embodiment, which has a first image sensor 10, a second image sensor 20, and a processing unit 30 having different modules 32, 34, 36, 38. First image sensor 10 and second image sensor 20 are situated in such a way that they record essentially the same scene. In the preferred exemplary embodiment, first image sensor 10 and second image sensor 20 form a stereo camera. In a stereo camera, not only do the two image sensors 10, 20 record essentially the same scene, but also the optical axes of the two image sensors 10, 20 are essentially parallel. In the preferred exemplary embodiment, both first image sensor 10 and second image sensor 20 are mounted at a mutual horizontal distance of approximately 0.2 m behind the windshield in the areas of the internal rear-view mirror of a motor vehicle. The two image sensors 10, 20 are oriented in such a way that their image detection area covers the surroundings of the motor vehicle in the direction of travel. In this exemplary embodiment, the lighting of the stereo camera pair is adjusted. If an error occurs in one of image sensors 10, 20, the lighting information for both image sensors 10, 20 together is obtained only from the image of the error-free image sensor 10, 20, while the erroneous lighting information of the defective image sensor 10, 20 is ignored. For example, if an error occurs in first image sensor 10, the lighting of both image sensors 10, 20 is adjusted as a function of the lighting information of second image sensor 20. For this purpose, the adjustment of image sensors 10, 20 is automatically switched over to the error-free image sensor 10, 20 for obtaining the lighting information.

For this purpose, a mechanism for automatic detection of error conditions is available in both image sensors 10, 20. The error conditions may be obtained either via monitoring functions of the hardware or via analysis of the images of image sensors 10, 20 for image errors. If an error is detected in one of image sensors 10, 20, the lighting information for both image sensors 10, 20 is obtained only on the basis of the error-free sensor. If both image sensors 10, 20 operate error-free, both image sensors 10, 20 are adjusted either individually or jointly. In the preferred exemplary embodiment, CMOS image sensors having a logarithmic lighting characteristic, which generate grayscale images having an eight-bit resolution, are used. First image sensor 10 transmits monitoring signals for error monitoring to module 32 via signal line 12. In a similar manner, monitoring signals are transmitted from second image sensor 20 to module 34 via signal line 22. In the preferred exemplary embodiment, image signals and different hardware signals of image sensors 10, 20, are transmitted as monitoring signals. Errors in the two image sensors 10, 20 are detected in error detection modules 32, 34 from the monitoring signals transmitted via signal lines 12, 22.

Error detection module 32 transmits error signals to image sensor switching module 36 via signal line 33. Error signals from error detection module 34 to image sensor switching module 36 are similarly transmitted via signal line 35. Depending on whether an error condition has been detected in the two image sensors 10, 20, one of the three cases explained below occurs in image sensor switching module 36.

In the first case, both image sensors 10, 20 operate error-free, and no error signals are transmitted to module 36 via signal lines 33, 35. Alternatively, it is possible to adjust both image sensors 10, 20, either jointly or individually. In the event of a joint adjustment, the lighting information from the two image sensors 10, 20 is averaged or combined in a joint grayscale histogram of both images. In the preferred exemplary embodiment, the lighting information is obtained in image sensor adjustment module 38 from image information transmitted to image sensor switching module 36 from first image sensor 10 via signal line 16 and from second image sensor 20 via signal line 26, and further to image sensor adjustment module 38 via signal line 37. In the case of individual adjustment, image sensors 10, 20 are either adjusted only with the help of the lighting information of one of the two image sensors 10, 20 or each image sensor 10, 20 is adjusted using its own lighting information.

In the second case, an error is detected in one of the two image sensors 10, 20. This error is transmitted from the corresponding error detection module 32, 34 to image sensor switching module 36 via one of signal lines 33, 35. In this case, only the lighting information of error-free image sensor 10, 20 is used in module 38 for adjusting both image sensors 10, 20. For example, when there is an error in first image sensor 10, image information of second image sensor 20 is transmitted via signal line 26 by image sensor switching module 36 and further to image sensor adjustment module 38.

If an error is detected simultaneously in both image sensors 10, 20, the third case is present. If it is a brief outlier, the instantaneous lighting information is ignored by image sensor adjustment module 38 and the lighting adjustment continues to run “blind.” This means that the adjustment is continued using the latest determined values until normal lighting conditions occur and/or until the error no longer exists in at least one image sensor 10, 20 and the lighting information of at least one image sensor 10, 20 may be used again for lighting adjustment. If the error continues in both image sensors, other measures must be taken. In the preferred exemplary embodiment, an alarm is given to the user, i.e., the driver of the motor vehicle, and/or the system is shut off. The actual lighting adjustment of image sensors 10, 20 is computed in module 38. For this purpose, adjustment signals are generated from the image information transmitted via signal line 37. The adjustment signals are transmitted to first image sensor 10 via signal line 14 and to second image sensor 20 via signal line 24. In the preferred exemplary embodiment the adjustment signals are signals for adjusting at least one lighting parameter. The electrical gain and/or the offset and/or the integration time is/are used as lighting parameters. In the preferred exemplary embodiment the lighting information is determined from the grayscale distribution of the transmitted image information. The mean of the grayscale values and/or a statistical value, in particular the median and/or the maximum and/or the minimum and/or the quantile of the grayscale histogram of the image information is/are used as lighting information.

In the preferred exemplary embodiment, individual modules 32, 34, 36, 38 of processing unit 30 are implemented in a digital microprocessor which achieves the above-described functions of these modules 32, 34, 36, 38 as programs, subprograms, or program steps. In another variant, at least two microprocessors containing individual modules 32, 34, 36, 38 are provided. The signals are transmitted over signal lines 12, 14, 16, 22, 24, 26, 33, 35, 37 electrically or optically. Alternatively or additionally, wireless transmission is possible. In a further variant of the preferred exemplary embodiment, both image sensors 10, 20 and processing unit 30 are combined to form a single unit.

The error detection modules for the image sensors detect errors of a certain type. A distinction is made between two types of errors: hardware errors and image errors. Failures of hardware components of the image sensors are recognized by detection circuits. Hardware components include in particular the electronic components for converting the light signal into an electrical signal, for example, at least one image sensor chip and/or the analysis electronics including microprocessors and memories in the image sensor. Detection circuits are electronic circuits which generate an error signal when an error occurs in one of the circuits to be monitored. Hardware error types include errors in the communication between the image sensor chip and the analysis electronics. The communication is often implemented via a bus protocol using appropriate error detection. The failure of individual bit levels is another type of hardware failure. This failure is typically manifested in the entire image being represented by only 1 or only 0 level bits. The existence of such a bit level error is determined by appropriately checking a sufficient number of bits of an image.

The second error type is image errors. The second error type (image error) includes in particular lighting errors and/or errors due to loss of contrast and/or highly distorted images. Lighting errors are recognized, for example, by analyzing the histogram of an image. In the case of overlighting or underlighting, an increase in the frequency of grayscale values in the upper or lower value range of the histogram occurs. Loss of contrast occurs, for example, when an image sensor is blocked. Such monocular errors are known in motor vehicles. If a stereo camera is operated behind the windshield and the windshield wiper is active at the same time, the windshield wiper briefly blocks one of the two image sensors in regular intervals. This results in temporary disturbance of the lighting adjustment of the image sensors. In particular, this causes the above-mentioned lighting errors and/or loss of contrast. Dynamic switch-over of the image sensor adjustment to the image sensor that is not blocked at the moment contributes to the prevention of such an undesirable condition. Highly distorted images occur, for example, at elevated operating temperatures and/or in the event of operating errors and/or communication errors of the image sensor chip.

The image error category also includes errors due to outlier images. Outlier images are understood as occasionally occurring image disturbances and/or changes in lighting and/or blocking affecting only a few consecutive images. Image disturbances occur, for example, in the event of intermittent electrical contacts in the electrical circuits of the image sensors, while changes in lighting occur, for example, in the event of brief interferences due to reflections of strong light sources. In the case of image sensors in motor vehicles, interference due to reflections is caused, for example, by the headlights of other motor vehicles. Blocking in the image of an image sensor of a stereo camera occurs in a motor vehicle, for example, due to the above-mentioned case of the windshield wiper. Such outlier images are detected via predictive methods and/or by detecting the difference between instantaneous and previous images. If the difference between instantaneous and previous images exceeds a previously defined threshold, the instantaneous image is considered an outlier.

The image error type also includes errors due to fuzzy images. Fuzzy images occur, for example, due to visibility impairments of the image sensors due to rain and/or dirt and/or water splash and/or defocusing. The occurrence of an error in one of the image sensors may be verified by comparing the right and left images of the stereo cameras. The difference between the right and left images is usually slight. However, if an error occurs in only one of the image sensors, in general also the error (difference) between the two images is magnified.

The above-described method and device for adjusting at least one image sensor of an image sensor system, where the image sensor system has at least two image sensors recording essentially the same scene, are not restricted to the adjustment of at least one lighting parameter. The above-described method and device are suitable in general for adjusting and/or controlling and/or regulating at least one parameter of at least one image sensor of an image sensor system, the image sensor system having at least two image sensors recording essentially the same scene. In addition to adjusting at least one lighting parameter, the adjustment and/or control and/or regulation of at least one focusing parameter is/are also possible. In today's image sensors, the focus of the image is adjusted automatically using autofocus. The focal distance of the image sensor lens is used, for example, as the focusing parameter. Alternatively or additionally, the aperture is adjusted as the parameter of at least one image sensor in other variants. Alternatively or additionally, in color reproduction image sensors, the white balance is adjusted as the parameter in another variant. Alternatively or additionally, the lighting sensitivity of the image sensor is adjusted in another variant. For example, in a particular embodiment, the lighting sensitivity of the image sensor is adjusted by adjusting the break points in a characteristic curve having linear segments. In another variant, at least two different parameters of at least one image sensor are adjusted simultaneously using the above-described method and device. When at least one error of at least one error type occurs in at least one image sensor, the at least two different parameters of this image sensor are adjusted as a function of at least one measured value of at least one further image sensor of the image sensor system.

An image sensor system having more than two image sensors recording essentially the same scene is used in one variant of the above-described method and device. Alternatively or additionally, at least one image sensor having a linear characteristic curve is used in a further variant. The image sensors used are not limited to black-and-white image sensors. Instead, the use of image sensors of different designs with respect to resolution and/or color depth and/or the lighting characteristic is possible. Alternatively or additionally, CCD image sensors of different designs with respect to resolution and/or color depth and/or the lighting characteristic may be used. In general, the above-described method, device, processing unit, and computer program are not limited to use in motor vehicles.

1-11. (canceled)

12. A method for adjusting at least one parameter of at least one image sensor of an image sensor system, the image sensor system including at least two image sensors which record essentially the same scene, the method comprising:
when at least one error of at least one error type occurs in at least one of the image sensors, adjusting at least one parameter of the at least one image sensor as a function of at least one measured value of at least one further of the image sensors of the image sensor system.

13. The method according to claim 12, wherein the image sensor system is in a motor vehicle.

14. The method according to claim 12, wherein the at least one parameter is at least one lighting parameter, including at least one of a gain, an offset and an integration time.

15. The method according to claim 12, wherein the at least one measured value is a measure of a lighting of at least one part of an image of the at least one further image sensor.

16. The method according to claim 12, wherein the at least one error type includes at least one of (a) at least one image error and (b) at least one hardware error.

17. A device for adjusting at least one parameter of at least one image sensor of an image sensor system, the image sensor system including at least two image sensors which record essentially the same scene, the device comprising:
a processing unit for adjusting at least one parameter of at least one of the image sensors as a function of at least one measured value of at least one further of the image sensors of the image sensor system in the event of an occurrence of at least one error of at least one error type in the at least one image sensor.

18. The device according to claim 17, wherein the image sensor system is in a motor vehicle.

19. The device according to claim 17, wherein the processing unit adjusts at least one lighting parameter, including at least one of a gain, an offset and an integration time, as a function of at least one measured value, the measured value being a measure of a lighting of at least one part of an image of the at least one further image sensor.

20. A processing unit for generating at least one adjustment signal for at least one parameter of at least one image sensor of an image sensor system, the processing unit comprising:
an arrangement for receiving at least two different images which represent essentially the same scene; and
an arrangement for monitoring an occurrence of at least one error of at least one error type in at least one image sensor of the image sensor system and, in the event of an occurrence of at least one error in the at least one image sensor of the image sensor system, for generating at least one adjustment signal for at least one parameter of the at least one image sensor as a function of at least one measured value of at least one further image sensor of the image sensor system.

21. The processing unit according to claim 20, wherein the image sensor system is in a motor vehicle.

22. The processing unit according to claim 20, wherein the at least one parameter includes at least one lighting parameter, including at least one of a gain, an offset and an integration time.

23. The processing unit according to claim 20, wherein the adjustment signal is generated as a function of at least one measured value, the measured value being a measure of a lighting of at least one part of an image of the at least one further image sensor.

24. The processing unit according to claim 20, wherein the at least one error type includes at least one of (a) at least one image error and (b) at least one hardware error.

25. A computer program contained in a computer-readable medium which when executed by a processor performs a method for adjusting at least one parameter of at least one image sensor of an image sensor system, the image sensor system including at least two image sensors which record essentially the same scene, the method including:
when at least one error of at least one error type occurs in at least one of the image sensors, adjusting at least one parameter of the at least one image sensor as a function of at least one measured value of at least one further of the image sensors of the image sensor system.

26. The computer program according to claim 25, wherein the image sensor system is in a motor vehicle.
